(19) United States
(12) Patent Application Publication
(10) Pub. No.: US 2002/0171770 A1
(43) Pub. Date: Nov. 21, 2002

(54) Television set having additional functions

(76) Inventors: Matthias Wendt, Wuerselen (DE); Gerwik Hoflich, Aachen (DE)

Correspondence Address: Philips Electronics North America Corporation, Corporare Patent Counsel, Tarrytown, NY, 10591, US

(21) Appl. No.: 10/110,300

(22) PCT Filed: Aug. 15, 2001
(86) PCT No.: PCT/EP01/09442

(30) Foreign Application Priority Data
Aug. 19, 2000 (DE) 10040680.7

(51) Int. Cl. H04N 5/14; H04N 9/64; H04N 3/24

(52) U.S. Cl. 348/634; 348/571

(57) ABSTRACT

The invention relates to a television set which offers additional functions. For this purpose the television set has a screen saver.

The invention relates to a television set which offers additional functions.

As the diagonals of display screens of television sets increase these television sets occupy more and more space in the house. Of course, they also occupy this space in the turned-off condition. The development of flat television sets (flat TV), which have smaller depths and which use flat plasma or LCD display screens, this problem is reduced in that they take up only small volumes and can be mounted on walls. However, they still occupy a large area on the wall, which area would otherwise be available for paintings or similar decorations. Moreover, the large gray surface of such a flat television set in the turned-off condition does not harmonize with a living room ambience.

It is an object of the invention to mitigate said drawbacks of large television sets, particularly in the case of flat television sets.

According to the invention this object is achieved in that a television set is equipped with a screen saver.

As the screen size of television sets increases these television sets are an increasing source of annoyance for the viewer. This is particularly so in the case of large plasma monitors mounted on the wall, which occupy a correspondingly large area. To spare the viewer this sight, a television set in accordance with the invention has a screen saver, which displays random images and films and which renders the television set also attractive when it is not used for the reproduction of a television program or of video films.

The embodiment as defined in claim 2 enables such screen savers to be stored. For this purpose, these television sets are equipped with a memory in which screen savers can be stored which the viewer enjoys when he does not use the television set for the reproduction of the current television program or of videos.

The embodiment as defined in claim 3 provides a possibility for a screen saver for television sets. Since in the present case the screen saver, unlike that for a computer, serves as an interior decoration of the house it must have an appropriate content. As still images it would be possible to display digitized personal photographs or digitized works of art which please the user. This is particularly practical when the viewer wishes to relax and prefers a still image as a quiet background. Instead of still images it is also possible to display moving pictures. This may then be a short movie stored in the memory, which film may also be a home-mode video such as a holiday video. However, it is alternatively possible to display a sequence of pictures or photographs which are changed at a given time interval, which time interval may be programmed separately by the user of the set or may be programmed differently for each picture or photograph.

With the embodiment as defined in claim 4 it is possible to reproduce sounds or music in addition to the still or moving pictures. This renders such a television set even more attractive. Thus, it is for example easy to realize a home-made or ready-made light and music show for use at parties.

Embodiments as defined in claim 5 relate to the transfer of the screen saver into the memory of the television set. This may be effected, on the one hand, via the connection of the television set to a data link such as the Internet and, on the other hand, the screen savers may be stored on floppy disks, CDs/DVDs, exchangeable memory elements or similar exchangeable storage media. For this purpose, the television set then includes a suitable deck or a suitable slot.

The embodiment as defined in claim 6 provides a further enlivenment and thus an increased attractiveness of a screen saver in accordance with the invention. By means of an infrared sensor the body heat of a person approaching the television set can be detected. When the detected heat increases or decreases this information can be used to influence the course of the current screen saver or to activate another screen saver. By means of a sensor capable of detecting the profiles of different persons it is thus possible to play an individual screen saver for each person as soon as the relevant person enters the room.

The embodiment as defined in claim 7 turns the display screen of the television set into a mirror. For this purpose, the television set should include a video camera which covers the environment of the television set. An arithmetic unit in the television set then calculates a mirror-inverted image of the environment from the images picked up and displays this on the display screen.

The embodiment as defined in claim 8 makes it possible for the user to have a screen saver made tailored to his wishes or to choose and order a screen saver from a virtual catalog. The user can select and order the desired screen saver from the virtual catalog via an entry terminal, for example a keyboard or a touch-sensitive display screen. The virtual catalog is preferably on the Internet because this enables an interactive communication to be realized without any problems.

The embodiment as defined in claim 9 is particularly suitable for the transmission of ready-made screen savers. Use is made of free transmission capacity in the transmission of a television program in a manner similar to the transmission of videotext. Thus, providers of programs can sell and transmit screen savers via their television channels.

With the embodiment as defined in claim 10 it is possible to simulate a view from a window on the display screen of the television set. Thus, a video camera may be installed outside a building, the camera view being shown on the display screen so as to give the viewer the impression that he is looking at his garden through a window. Instead of pictures from such an outdoor camera it is, of course, possible to transmit pictures from a so-called webcam via a data link such as an Internet connection. Webcams are video cameras located anywhere on the globe and whose images can be retrieved via any Internet connection. Thus, figuratively speaking, the viewer can bring the whole world into his living room.

The advantages of the invention are particularly are apparent in particular from the embodiment as defined in claim 11 because large wall-mounted flat display screens are particularly suitable for the simulation or the display of window views and paintings or photographs.

The present invention will now be described in more detail with reference to the following example.

A large-screen television set having a plasma display as its display screen uses a largely digital signal processing. Since the individual pixels are digitally driven the television program, which at the moment is still often received in analog form is first digitized and then reproduced on the display screen. Therefore, it is readily possible to reproduce other digital signal sources on such a television set. For this purpose, the television set has a digital memory in which screen savers can be stored. Furthermore, the television set has a CD/DVD deck adapted to receive and play back storage media carrying screen savers. The CD/DVD may carry ready-made purchased images, photographs, works or art or short films. However, such a CD/DVD may alternatively carry work created by the user.

When the television set not being used for the reproduction of television programs or video films, it is switched to a further mode of operation and starts with the display of a screen saver selected by the user. Thus, the user can play and enjoy, for example, digitized pictures of the last vacation as the background for a dinner. By means of an internet connection it is possible to load arbitrary images into the screen saver at any time, thereby also enabling images from webcams all over the world to be displayed. Thus, the television set can display, for example, a sunset in the Pacific Ocean, which gives the viewer the sensation as though he is looking through the window directly into the Pacific Ocean. Instead of via the Internet such images could also be transmitted by television companies in a manner similar to videotext parallel to the current television program. It will be obvious that the memory, the connections and the electronic circuits for displaying such a screen saver may also be incorporated into a video projector or in a rear-projection television set because these are particularly suitable for the display of large images.

1. A television set having a screen saver.

2. A television set as claimed in claim 1, characterized in that the screen saver has been provided in a digitized form for the storage in at least one digital memory element in a television set.

3. A television set as claimed in claim 1, characterized in that the screen saver displays still, moving or changing images.

4. A television set as claimed in claim 2 or 3, characterized in that the screen saver in addition reproduces sounds, sound effects or music.

5. A television set as claimed in claim 1, characterized in that provision has been made to transfer the images and films of the screen saver into the memory of the television set via at least one data carrier or at least one data link.

6. A television set as claimed in claim 1, characterized in that a sensor has been provided for the purpose of controlling the display of the images and films of the screen saver in dependence on the presence of persons.

7. A television set as claimed in claim 1, characterized in that at least one camera in conjunction with an arithmetic unit has been provided in order to produce a mirror image of the environment on the display screen of the television set as a screen saver.

8. A television set as claimed in claim 1, characterized in that films, images or works of art can be ordered as screen savers with the aid of an entry terminal.

9. A television set as claimed in claim 1, characterized in that the screen saver is adapted to be transmitted parallel to the current television program via a television channel.

10. A television set as claimed in claim 1 characterized in that the screen saver displays the image from at least one video camera, which shows the environment of a building.

11. A television set as claimed in claim 1, characterized in that the television set has a flat display screen and is adapted to be mounted on a wall.
